(19) United States
(12) Patent Application Publication
(10) Pub. No.: US 2023/0192422 A1
(43) Pub. Date: Jun. 22, 2023

(54) DEVICE FOR LIFTING PACKING MATERIAL

(71) Applicant: MULTIVAC SEPP HAGGENMUELLER SE & CO. KG, Wolfertschwenden (DE)

(72) Inventors: Rainer HAERING, Lauben (DE); Maximilian BRUNNER, Westerheim (DE)

(73) Assignee: MULTIVAC SEPP HAGGENMUELLER SE & CO. KG, Wolfertschwenden (DE)

(21) Appl. No.: 18/086,320

(22) Filed: Dec. 21, 2022

(30) Foreign Application Priority Data
Dec. 21, 2021 (DE) 102021133948.0

(51) Int. Cl. B65G 47/91; B65B 43/28

(52) U.S. Cl. CPC B65G 47/917; B65B 43/28

(57) ABSTRACT

The disclosure relates to a device for automatically lifting a packing material comprising a lifting element movable between a lower removal position and an upper transfer position, a vacuum source configured to create a negative pressure, a drive element, and a suction element, which has at least one opening of a vacuum line and is mechanically connected to the lifting element and is fluidically connected to the vacuum source by means of the vacuum line. The lifting element is configured to place the suction element on an uppermost packing material of a stack of packing materials by its weight force in the lower removal position, wherein the opening of the vacuum line can be closed in an airtight manner, and wherein the lifting element is configured to move together with the sucked packing material into the upper transfer position.

### CROSS-REFERENCE TO RELATED APPLICATIONS

This application claims foreign priority benefits under 35 U.S.C. § 119(a)-(d) to German patent application number DE 10 2021 133 948.0, filed Dec. 21, 2021, which is incorporated by reference in its entirety.

### TECHNICAL FIELD

The disclosure relates to a device for lifting a packing material and to a method for lifting a packing material.

### BACKGROUND

A device for opening bags or packing materials is known from EP 1 465 809 B1. This device includes a product information acquisition station, which detects the size of a product to be packaged, and an automatic bag opener, which reaches into the interior of an unopened bag by means of an expanding finger and then opens it completely.

A bag opener is known from DE 10 2017 002 052 B4, which has a blower through which a bag or pouch is inflated.

The devices known from the prior art usually have, in addition to the separation, mechanical expanding fingers, which are moved in different directions to open a bag. The disadvantage of this solution is that several drive elements or complex mechanics are necessary to open bags. Alternatively, the closed bag is inflated with the help of an air stream. A disadvantage of this configuration is that a sterile inner side of the bag can become contaminated.

### SUMMARY

A problem of the disclosure is to provide a device which, using simple, technical constructive means, offers an effective, inexpensive and ergonomic provision of packing means, in particular bags. It is also, or alternatively, an object of the disclosure to provide a, preferably partially opened, bag for an operator.

A device according to the disclosure for automatically lifting a packing means comprises:

a lifting element movable between a lower removal position and an upper transfer position;

a vacuum source configured to create a negative pressure;

a drive element for driving the lifting element to the upper transfer position; and

a suction element, which has at least one opening of a vacuum line and is mechanically connected to the lifting element and is fluidically connected to the vacuum source by means of the vacuum line. The disclosure is characterized in that the lifting element is configured to place the suction element on the uppermost packing material of a stack of packing materials by its weight force in the lower removal position, wherein the opening of the vacuum line can be closed in an airtight manner, wherein the lifting element is configured to move together with the sucked packing material into the upper transfer position, driven by the drive element.

Preferably, the drive element can be actuated by means of vacuum. Particularly preferably, the drive element is connected to the vacuum line. This offers the advantage that the entire device requires only one drive element and one vacuum source.

Furthermore, the lifting element can preferably be lowered into the lower position by releasing the opening of the vacuum line at the suction element by removing the packing material by means of its weight force. The bag is thus held or provided in the upper transfer position until it is actively removed by an operator. Consequently, the next work cycle is started automatically purely by the operator removing the packing material. No additional components or process steps are required to start the next work cycle.

According to a preferred embodiment of the present disclosure, the device comprises a throttle element which is fluidically connected to the drive element on the side thereof facing away from and/or towards the vacuum source. This makes it possible to influence the speed at which the lifting element lowers.

Stocked packing materials or bags are usually folded flat. To open a bag, two sides forming an opening of the bag must be grasped in order to detach them from each other. Due to electrostatic charge, these two sides often adhere to each other. Therefore, it is often not easy to open a bag by hand. It is therefore particularly preferred in the present disclosure to have at least two suction elements which are movable relative to one another. This slightly deforms the bag, causing the bag to open slightly. This makes it considerably easier for the operator to open the bag further.

Additionally or alternatively, it is conceivable that all suction elements act on the same side of the packing material. It is also particularly preferred if all suction elements are located on the upward-facing side of the packing material. This greatly simplifies the structural layout of the device according to the disclosure.

One embodiment of the disclosure provides that the relative movement of the at least two suction elements is coupled with a movement, in particular lifting, of the lifting element. It is also conceivable that the movement coupling is implemented by means of a coupling gear. Thus, an additional drive element can be dispensed with, which simplifies the structural layout of the device.

The disclosure further relates to a method for automatically lifting a packing material.

The method according to the disclosure for operating a device for automatically lifting a packing material comprises the following steps:

placing a suction element arranged on a lifting element onto the packing material by means of at least the weight force of the lifting element in a lower removal position;

sucking the packing material by means of the suction element forming the opening of a vacuum line, by means of negative pressure of a vacuum source connected to the vacuum line;

moving the lifting element by means of a drive element to an upper transfer position to lift the packing material from a stack of packing material; and

removing, preferably manually, the packing material from the suction element.

In one conceivable embodiment, the vacuum source, by sealing the vacuum line through the packing material, acts on the drive element. This allows the device to be operated using only a single vacuum source and a single drive element, which permits a simple and reliable configuration.

Preferably, removing the packing material from the suction element opens the vacuum line to the environment, and thus the weight force acting on the lifting element exceeds the force acting on the lifting element from the drive element. Consequently, purely as a result of the operator removing the packing material, the next work cycle is automatically started. No additional components or process steps are required to start the next work cycle.

In a further embodiment of the disclosure, at least two suction elements are provided which perform a relative movement with respect to one another, wherein this relative movement is performed simultaneously with the movement of the lifting element. As a result, the bag is slightly deformed, causing the bag to open slightly. This makes it much easier for the operator to open the bag further.

Particularly preferably, the relative movement is carried out by means of a coupling gear between the suction elements and the lifting element. This means that there is no need for an additional drive element, which simplifies the structural layout of the device.

### BRIEF DESCRIPTION OF THE DRAWINGS

In the following, a preferred embodiment of the disclosure is shown in more detail with reference to a drawing. In detail:

FIG. 1 shows a side view of a device according to the disclosure in the lower removal position;

FIG. 2 shows a side view of the device according to the disclosure in the upper transfer position;

FIG. 3 shows a perspective view of the device according to the disclosure

FIG. 4A shows a top view of the device according to the disclosure in the lower removal position;

FIG. 4B shows a front view of the opening of a packing material in the lower removal position;

FIG. 5A shows a top view of a device in the upper transfer position; and

FIG. 5B shows a front view of the opening of the packing material in the upper transfer position.

### DETAILED DESCRIPTION

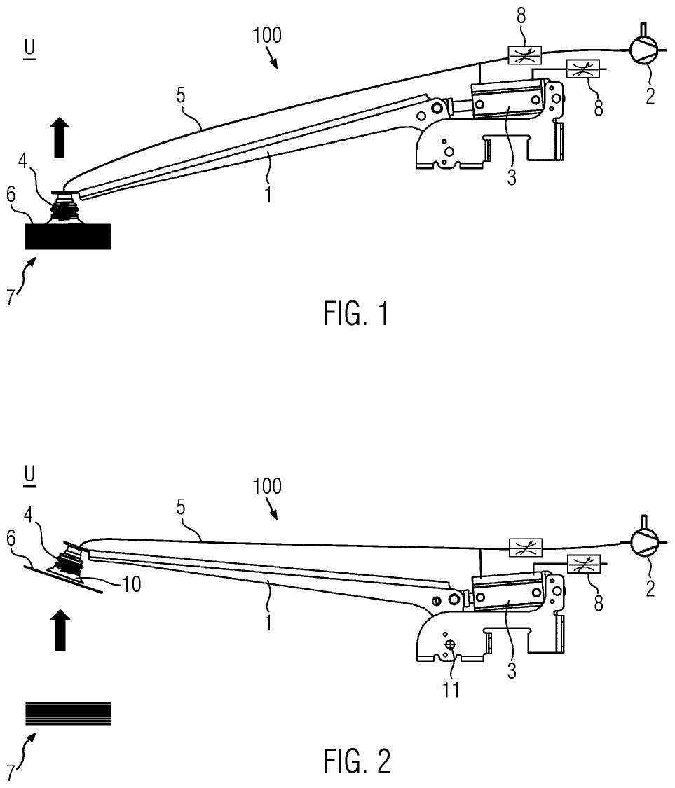

FIG. 1 shows a side view of a device 100 according to the disclosure in the lower removal position. A lifting element 1 with a suction element 4 attached to it rests on an uppermost packing material 6 of a stack of packing materials 7. The lifting element 1, which may be a pivotable arm, for example, as shown in FIG. 1, is mechanically connected to a drive element 3, such as a pneumatic drive (e.g., pneumatic cylinder). A vacuum line 5 connects the drive element 3 to the suction element 4, which may be a suction cup, vacuum cup, plunger, aspirator, suction housing or suction bell, for example. In addition, the vacuum line 5 is connected to a vacuum source 2. Furthermore, the drive element 3 is connected to a throttle element 8 or a throttle element 8 is present in the vacuum line 5.

A vacuum is constantly present at the vacuum source 2. As long as no packing material 6 is in contact with the suction element 4, the vacuum line 5 is open to the surrounding area U. The force generated by the drive element 3 on the lifting element 1 is significantly smaller than the weight force acting on the lifting element 1. If the opening 10 of the vacuum line 5 is now closed by the packing material 6, the vacuum line 5 and also the drive element 3 are no longer ventilated. The vacuum source 2 now acts on the drive element 3. The force acting on the drive element 3 on the lifting element 1 is now greater than the weight force acting on the lifting element 1. The lifting element 1 moves upward, in this case by means of a pivoting movement about a pivot axis 11.

FIG. 2 shows a side view of the device 100 according to the disclosure in the upper transfer position. As long as the packing material 6 is in contact with the suction element 4, the lifting element 1 remains in the upper transfer position.

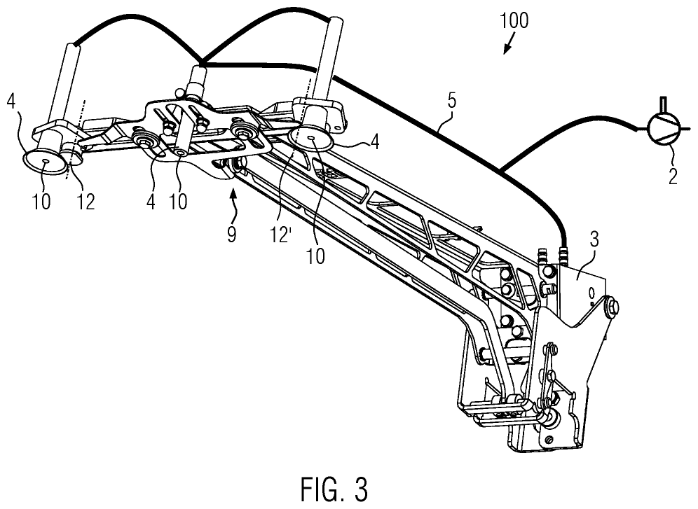

FIG. 3 shows a preferred embodiment of the device 100 according to the disclosure in a perspective view. Here, the vacuum line 5 has three openings 10 at three suction elements 4. In addition, the outer two suction elements 4 are each mounted movably about an axis of rotation 12, 12′. By means of a coupling gear 9, the suction elements 4 are coupled to the lifting element 1. A movement of the lifting element 1 causes a movement of the suction elements 4 through the coupling gear 9. The suction elements 4 move about their respective axis of rotation 12, 12′. The two suction elements 4 move relative to each other.

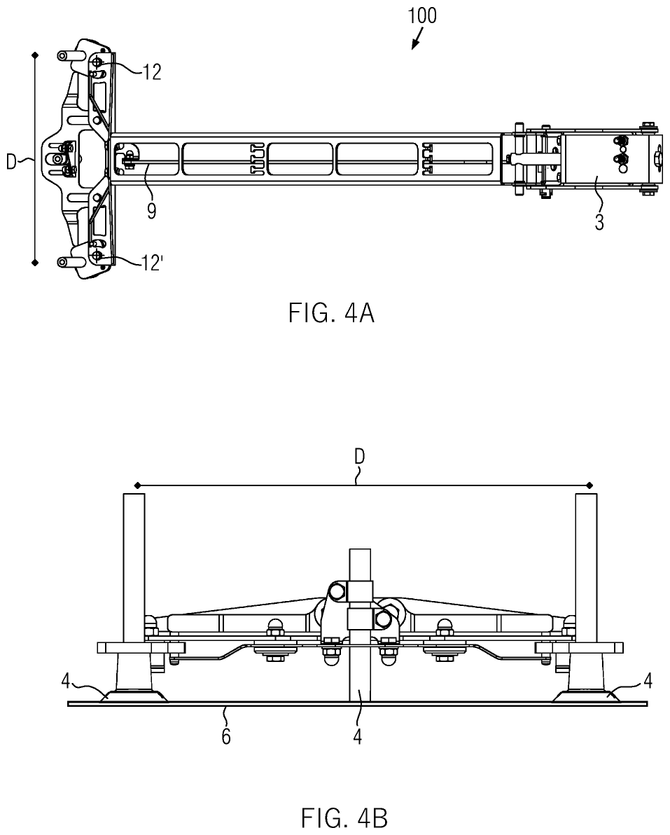

FIG. 4A shows a top view of a preferred embodiment of the device 100 according to the disclosure in the lower removal position. The outer two suction elements 4 are at a distance D from each other.

FIG. 4B shows a front view of the packing material 6, in particular the opening of a bag. The upper side of the bag is sucked by all three suction elements 4.

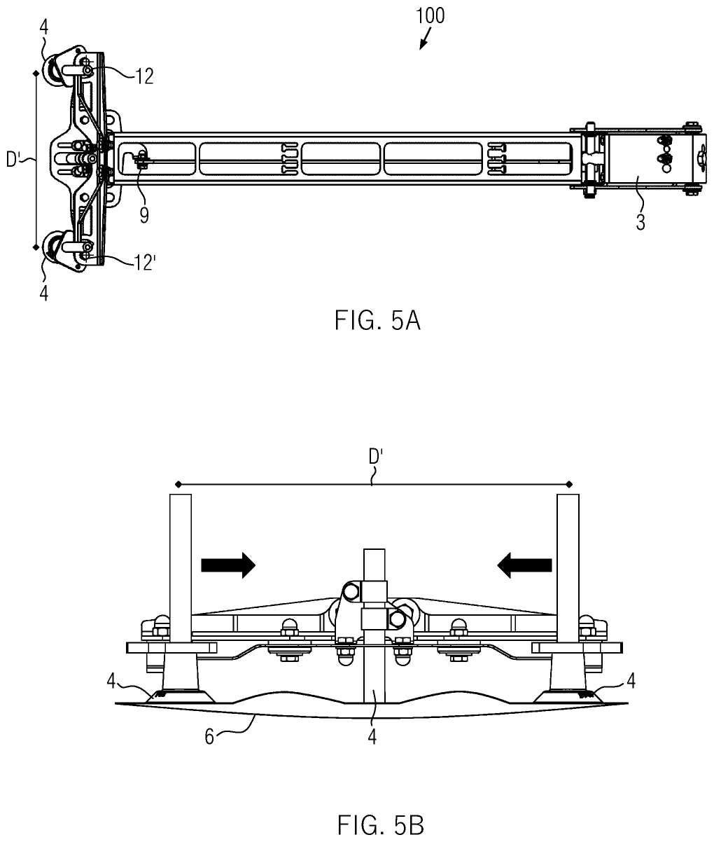

FIG. 5A shows a top view of a preferred embodiment of the device 100 according to the disclosure in the upper transfer position. The outer two suction elements 4 have been moved—by the coupling gear 9—relative to each other to the distance D′, which is smaller than the distance D.

FIG. 5B shows a front view of the packing material 6, in particular the opening of a
now opened—bag. The relative movement of the two outer suction elements 4 to the distance D′ compresses the upper side of the packing material 6. The lower side of the packing material 6 is also deformed by the movement of the suction elements 4. This causes the packing material 6 to open slightly. Thus, the packing material 6 can be easily removed by an operator in an open state.

### LIST OF REFERENCE SIGNS

1 lifting element
2 vacuum source
3 drive element
4 suction element
5 vacuum line
6 packing material
7 stack of packing material
8 throttle element
9 coupling element (coupling gear)
10 opening vacuum line
11 pivot axis
12, 12′ axes of rotation
U environment
D first distance of the suction elements
D′ second distance of the suction elements
100 device

What is claimed is:

1. A device for automatically lifting a packing material, comprising:
a lifting element movable between a lower removal position and an upper transfer position;
a vacuum source configured to create a negative pressure;
a drive element for driving the lifting element to the upper transfer position; and
a suction element, which has an opening of a vacuum line and is mechanically connected to the lifting element and is fluidically connected to the vacuum source by the vacuum line, wherein the lifting element is configured to place the suction element on an uppermost packing material of a stack of packing materials by its weight force in the lower removal position, the opening of the vacuum line can be closed in an airtight manner when the packing material is sucked by the suction element, and the lifting element is configured to move together with the sucked packing material into the upper transfer position, driven by the drive element.

2. The device according to claim 1, wherein the drive element is actuatable by means of negative pressure.

3. The device according to claim 1, wherein the drive element is connected to the vacuum line.

4. The device according to claim 3, wherein by releasing the opening of the vacuum line at the suction element by removing the packing material, the lifting element can be lowered into the lower removal position by its weight force.

5. The device according to claim 4, wherein a throttle element is fluidically connected to the drive element on a side facing away from and/or towards the vacuum source.

6. The device according to claim 1 further comprising an additional suction element, wherein the suction element and the additional suction element are movable relative to one another.

7. The device according to claim 6, wherein the suction elements are configured and arranged to engage a same side of the packing material.

8. The device according to claim 7, wherein the additional suction element has an additional opening fluidically connected to the vacuum source, and, in the lower removal position of the lifting element, the opening of the suction element and the additional opening of the additional suction element point downwards.

9. The device according to claim 8, wherein the device is configured to operate so that relative movement of the suction elements is coupled with a lifting movement of the lifting element.

10. The device according to claim 9, further comprising a coupling gear configured to couple the relative movement of the suction elements with the lifting movement of the lifting element.

11. A method of operating a device for automatically lifting a packing material, comprising:
placing a suction element arranged on a lifting element onto the packing material by at least weight force of the lifting element in a lower removal position;
sucking the packing material by the suction element comprising at least one opening of a vacuum line, by negative pressure of a vacuum source connected to the vacuum line;
moving the lifting element by a drive element to an upper transfer position to lift the packing material from a stack of packing materials; and
removing the packing material from the suction element.

12. The method according to claim 11, wherein by sealing the vacuum line through the packing material, the vacuum source acts on the drive element.

13. The method according to claim 12, wherein by removing the packing material from the suction element the vacuum line is opened towards the environment and the weight force acting on the lifting element exceeds force acting on the lifting element from the drive element.

14. The method according to claim 13, wherein the device comprises an additional suction element, the suction element and the additional suction element perform a relative movement to each other and the relative movement is performed simultaneously with movement of the lifting element.

15. The method according to claim 14, wherein the relative movement is carried out by a coupling gear between the suction elements and the lifting element.

16. A device for automatically lifting a packing material, the device comprising:
a lifting element movable between a lower removal position and an upper transfer position;
a vacuum source configured to create a negative pressure;
a drive element configured to drive the lifting element to the upper transfer position; and
a suction element mechanically connected to the lifting element and defining an opening that is fluidically connected to the vacuum source, wherein the lifting element is configured to place the suction element on an uppermost packing material of a stack of packing materials by its weight force in the lower removal position, the opening can be closed in an airtight manner when the packing material is in contact with the suction element, and the lifting element is drivable by the drive element to move together with the packing material into the upper transfer position when the packing material is in contact with suction element.
